(19) United States
(12) Patent Application Publication
(10) Pub. No.: US 2010/0274807 A1
(43) Pub. Date: Oct. 28, 2010

(54) Method and system for representing information

(76) Inventor: Frank John Williams, Los Alamitos, CA (US)

Correspondence Address: Frank J. Williams, 2711 Saint Albans Dr., Los Alamitos, CA, 90720, US

(21) Appl. No.: 12/386,920

(22) Filed: Apr. 23, 2009

(51) Int. Cl. G06F 17/30

(52) U.S. Cl. 707/776; 707/E17.071

(57) ABSTRACT

A preferred method and system for dynamically and/or statically identifying, manipulating, registering and comparing information are disclosed. In a preferred method, the elements and their respective associations respective to a data string or corpus are identified and/or represented through corresponding network elements and/or configurations. In addition, this disclosure further teaches the methodology of implementing the disclosed methodology of “informational networks” to perform an information application such as that of a search engine while effectively avoiding semantic irrelevance or selecting only relevant information with restrictions of a given grammar.

### BACKGROUND

1. Field of Invention

The present invention relates generally to a method for identifying information. More particularly, a novel method for identifying, registering and manipulating language information and other forms of information implementing a system network.

2. Description of Related Art

The computer and Internet revolutions are responsible for a series of innovations, scientific disciplines and applications, such as the Internet, computational linguistics, speech recognition, word processing, search engines and many others which have inherently changed the life and culture of the human and surrounding species. However, current technology fails to effectively manipulate language and information due to its lacking ability to diverge from specific grammatical structures thus avoiding and neglecting conceptually equivalent information. For example, in English, the words “red shoes” clearly and specifically define those items (shoes) which are identifiable by particular chromatic disposition (red). However, the same words as a query in today's search engines inevitably will generate all sorts of documents and sites simply comprising the words “red” and “shoes” in any random use or context. As a result, the query, will erroneously retrieve sites such as “the red car is a great option to show your new shoes” or “the white shoes look nice but your problem is the red scarf.” which indeed completely fail to express or respect the linguistic concept implied in the query. Then, to complicate things even further, human languages naturally permit dissimilar grammatical structures to express identical things, meanings and concepts. For example, in context, “the shoes are red” and “red shoes,” are and mean the same thing, further crippling and limiting the ability for machines and intelligent systems to effectively manipulate language and information.

In view of the present shortcomings, the present invention distinguishes over the prior art by providing heretofore a method and system to identify, to store, and to handle information in a more compelling way and manner, thus allowing current and future information systems the ability to handle information conceptually, while providing additional, unknown, unsolved and unrecognized advantages as described in the following disclosure.

### SUMMARY OF THE INVENTION

The present invention teaches certain benefits in use and construction which give rise to the objectives and advantages described below. The methods and systems embodied by the present invention overcome the limitations and shortcomings encountered when manipulating language information. The method(s) permits to identify information, register information, control information and manipulated information in context to its natural language, overcoming grammatical structures while avoiding conceptually irrelevant, erroneous and nonsensical data.

### Objects and Advantages

A primary objective inherent in the above described methods and systems of use is to provide a system and methods for identifying, registering, controlling, and handling language information as intended by its context while allowing to overcome limiting grammatical structures not taught in the prior arts while providing further advantages and objectives not taught by the prior art. Accordingly, several objects and advantages of the invention are:

Another objective is to avoid the generation of irrelevant and nonsense data during searching.

Another objective is to save user time by providing only conceptually matching data.

A further objective is to decrease the amount of effort implemented by users discriminating for irrelevant and nonsense data.

A further objective is to decrease the amount of effort implemented by users searching for relevant data.

A further objective is to improve the quality and quantity of results.

A further objective is to permit machines and programs to handle language more efficiently.

A further objective is to improve the ability of devices and portable devices to manipulate language information.

Another further objective is to permit the unification of the world's knowledge regardless of language and/or grammar.

Other features and advantages of the described methods of use will become apparent from the following more detailed description, taken in conjunction with the accompanying drawings which illustrate, by way of example, the principles of the presently described apparatus and method of its use.

### BRIEF DESCRIPTION OF THE DRAWINGS

The accompanying drawings illustrate examples of at least one of the best mode embodiments of the present method and methods of use. In such drawings:

FIG. 1A through FIG. 1C are exemplary non-limiting block diagram of several networks comprising some elements of the inventive method and system;

FIG. 2A and FIG. 2B are non-limiting exemplary block diagrams of steps and some elements of the inventive method;

FIG. 3A through FIG. 3G are non-limiting exemplary block diagram illustrations of events resulting from steps of the inventive method;

FIG. 4 is a non-limiting illustration of a network of two systems communication across a OCL and a NCCL;

FIG. 5A and FIG. 5B are non-limiting exemplary block diagram illustrations of the inventive method handling an information function or application such as a search engine;

### DETAILED DESCRIPTION

The above described drawing figures illustrate the described methods and systems and use in at least one of its preferred, best mode embodiment, which are further defined in detail in the following description. Those having ordinary skill in the art may be able to make alterations and modifications from what is described herein without departing from its spirit and scope. Therefore, it must be understood that what is illustrated is set forth only for the purposes of example and that it should not be taken as a limitation in the scope of the present system and method of use.

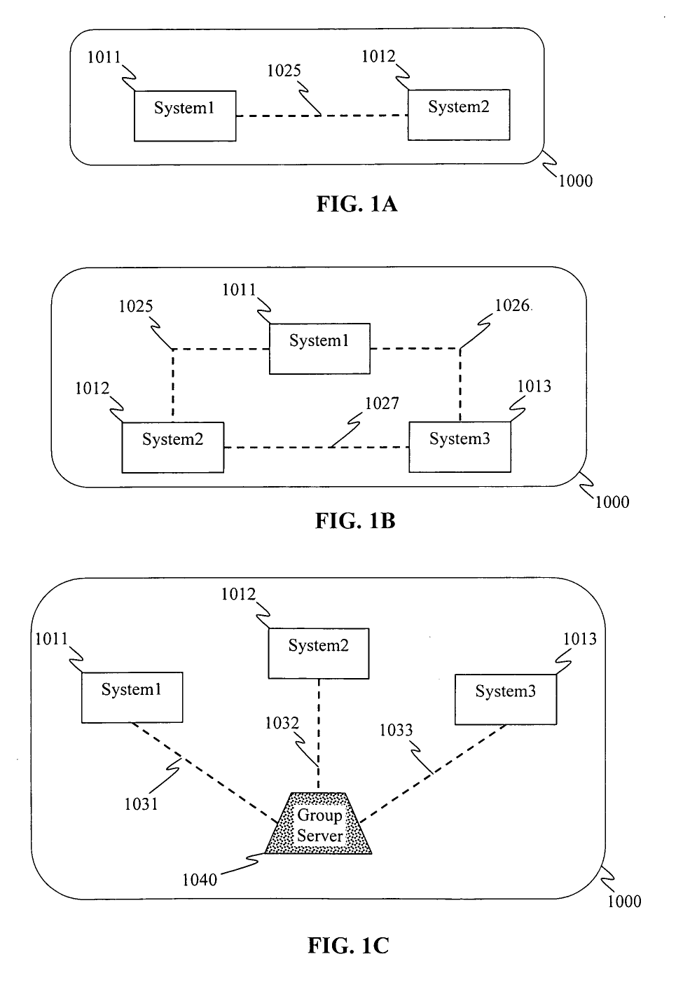

FIG. 1A illustrates an exemplary block diagram of a network comprising some elements of the inventive method and system. The First Network 1000 (FIG. 1A) comprises several systems such as the First System 1011 (FIG. 1A) or System1, such as a computer, server, chip, and processor which communicates with the Second System 1012 (FIG. 1A) or System2, such as a computer, server, chip, and processor via an Original Communication Line 1025 (FIG. 1A) or OCL for short. Please note the OCL is depicted as a dashed line to later differentiate it from other new, replacing, overriding and/or newly established communication lines.

FIG. 1B illustrates an exemplary block diagram of another network comprising some elements of the inventive method and system. The Network 1000 (FIG. 1A) comprises several systems such as the First System 1011 (FIG. 1B) and the Second System 1012 (FIG. 1B); wherein both systems can communicate with each other via a First OCL 1025 (FIG. 1B). In addition, the First System 1011 (FIG. 1B) and the Third System 1013 (FIG. 1B) can both communicate with each other via a Second OCL 1026 (FIG. 1B). Finally, The Second System 1012 (FIG. 1B) and the Third System 1013 (FIG. 1A) can both communicate with each other via a Third OCL 1027 (FIG. 1B). As a result, all systems have sufficient means to communicate with each other. Please note, the OCL are again depicted as dashed lines; wherein dashed lines are used to identify previously existing lines, thus to be differentiate them from new, newly formed, newly approved, newly created and other types of communication lines.

FIG. 1C illustrates an exemplary block diagram of another network comprising additional elements of the inventive method and system. The Network 1000 (FIG. 1C) comprises several systems such as the First System 1011 (FIG. 1C) and the Group Server 1040 (FIG. 1C), such as a computer, server, chip, processor, router, which communicate with each other via a First OCL 1031 (FIG. 1C). Also, the Second System 1012 (FIG. 1C) and the Group Server 1040 (FIG. 1C) communicate with each other via a Second OCL 1032 (FIG. 1C). Finally, the Third System 1013 (FIG. 1C) and the Group Server 1040 (FIG. 1C) communicate with each other via a Third OCL 1033 (FIG. 1C). As a result, all Systems have sufficient means (such as several existing OCL), and capabilities to communicate with each other through the Group Server.

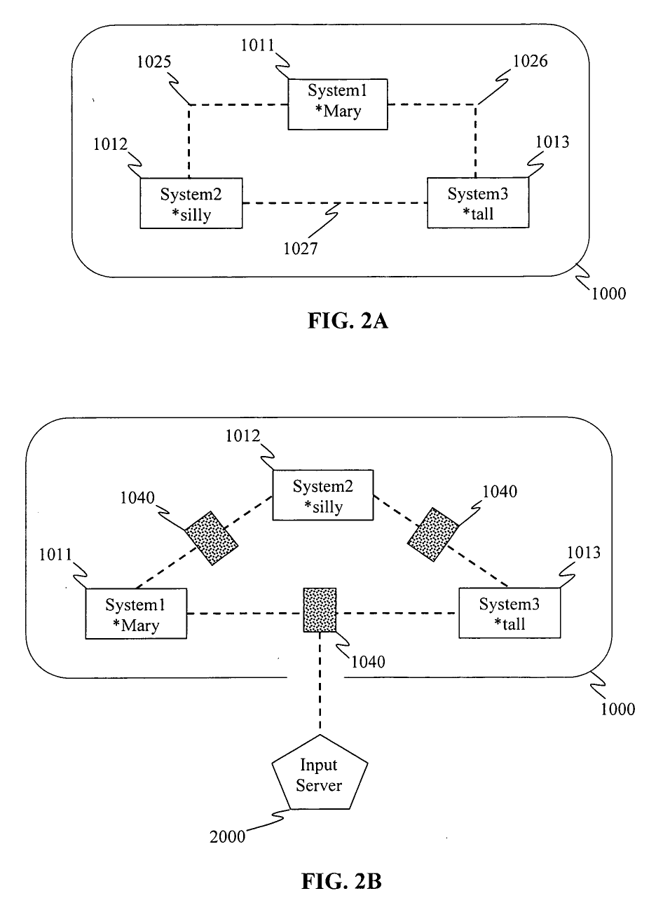

FIG. 2A is a non-limiting exemplary block diagram of a step and some elements of the inventive method. In this example, the First System 1011 (FIG. 2A) identifies and/or represents the word and/or concept of “*Mary.” Please note, the special terminology of *Mary is understood as any information which directly (such as text) or indirectly (such as a group identifier, eeggi, eeggi-grammar and others) is capable of identifying the concept of “Mary.” In similar fashion, the Second System 1012 (FIG. 2A) is responsible for identifying and/or representing its assigned concept of “silly” or better said, “*silly,” to represent any information directly and/or indirectly capable of identifying the meaning of “silly.” Finally, the Third System 1013 (FIG. 2A) is responsible for identifying and/or representing the word or concept of “tall” or *tall in more general terms. As a result, in this Network 1000 (FIG. 2A), all systems can communicate with each other.

FIG. 2B is another non-limiting exemplary block diagram of a step and a more complex network of the inventive method. In this example, there are four elements forming the Network 1000 (FIG. 2B) and an Input Server 2000 (FIG. 2B) for allowing exterior communications to and/or from the Network. Accordingly, the First System 1011 (FIG. 2B), identifying and/or representing the word and/or concept of “Mary” (*Mary), is capable of communicating with the Group Server 1040 (FIG. 2B). In similar fashion, the Second System 1012 (FIG. 2B) which is responsible for identifying and/or representing its assigned concept of “silly” (*silly), and the Third System 1013 (FIG. 2A) which is responsible for identifying and/or representing the word or concept of “tall” (*tall) can communicate with the Group Server 1040 (FIG. 2B). Finally, the Input Server 2000 (FIG. 2B) communicates with network or Group Server 1040 (FIG. 2B).

Noteworthy, there are several kinds, types, and configurations available to ultimately comprise and/or bestow a network, such as network implementing wireless means, networks through satellite links, etc. without ever departing from at least one scope and spirit of the inventive method, which in this particular examples, depicts the step of implementing a system within the network to identify a particular concept, such as the example wherein the First System 1011 (FIG. 2B) is used to represent and/or identify the concept of “Mary” or *Mary (any information directly and/or indirectly capable of identifying Mary). Accordingly, in order to avoid the excessive implementation of figures depicting all kinds, types and configurations of networks, the present figures will suffice and exemplify all kinds, types and configurations of possible available networks.

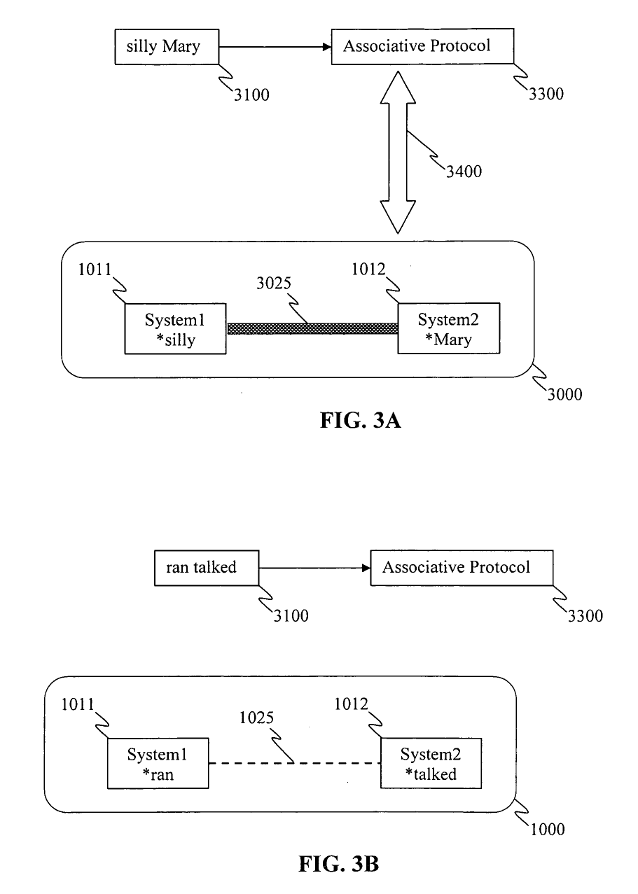

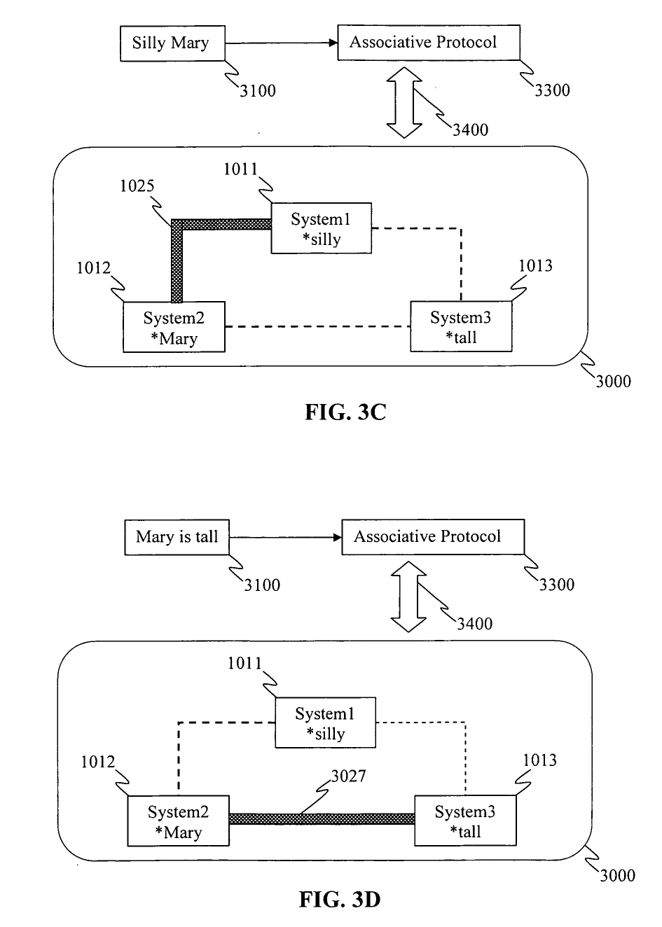

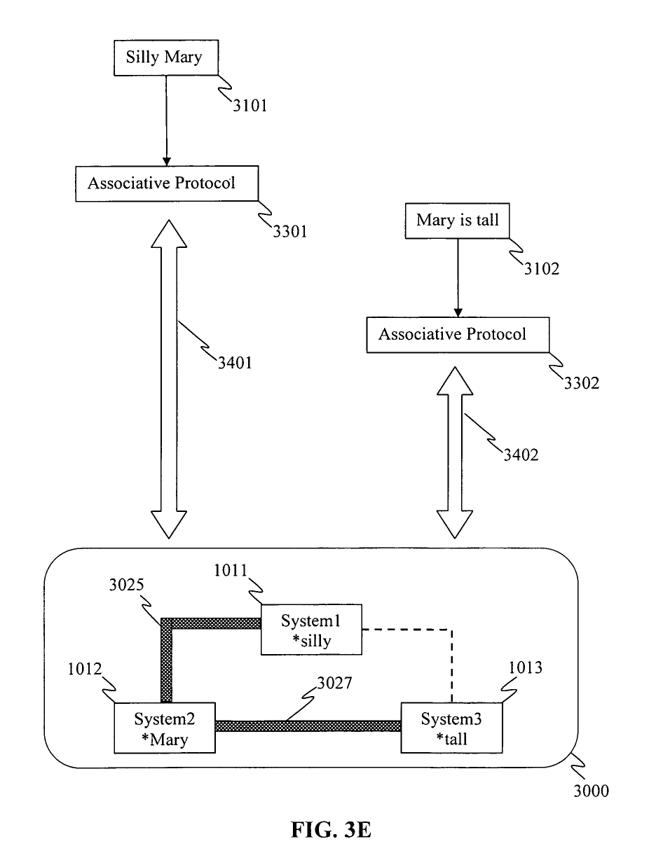

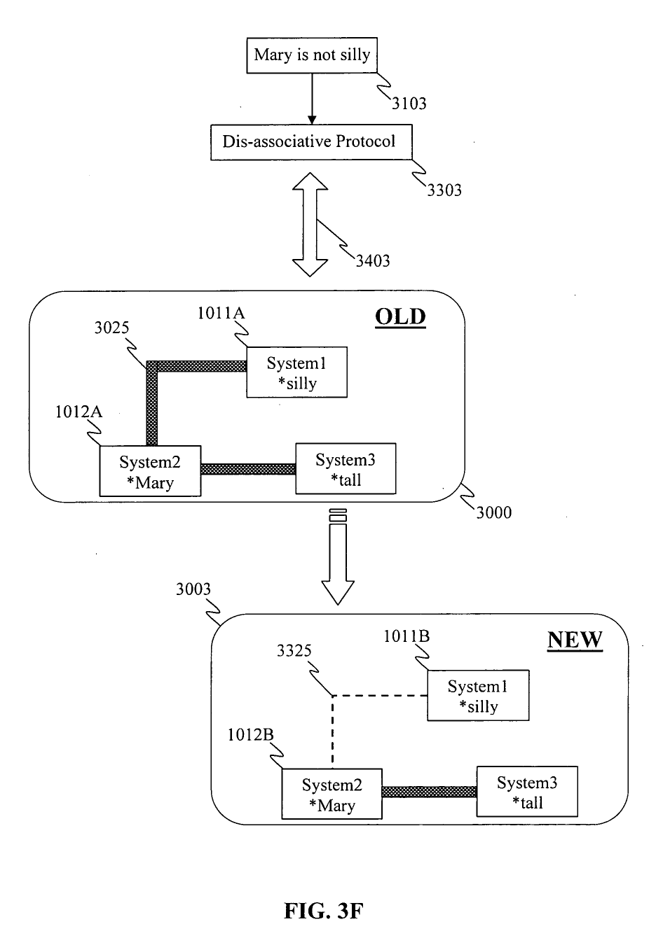

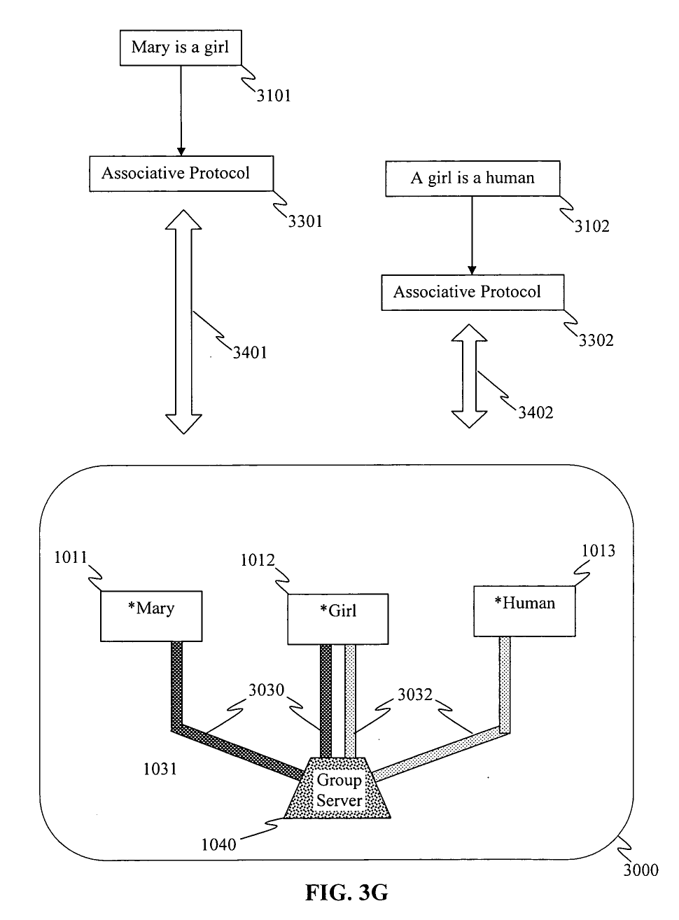

FIG. 3A is a non-limiting exemplary block diagram illustration of a step of the inventive method. A Data String 3100 (FIG. 3A) such as “silly Mary” is analyzed implementing an Associative Procedure 3300 (FIG. 3A), such as CIRN, to verify and/or discover if an association is present and/or possible between the elements of the said Data String. In this particular example, an association is indeed identified (verified and/or existent) between the elements of said Data String, thus resulting in a data transmission as indicated by the Block Transmission Arrow 3400 (FIG. 3A). Said transmission, comprises at least one of a: association commands, association information, communications converter, communications identifier, etc. is sent or is provided to at least one of the systems identifying the respective elements of the said Data String and/or said identified association. As a result, the First System 1011 (FIG. 3A) or the system of *silly, and the Second System 1012 (FIG. 3A) or system of *Mary, now communicate across the New Conceived Communication Line 3025 (FIG. 3A) thus forming the New Conceived Network 3000 (FIG. 3A). Please note, the depicted New Conceived Communication Line 3025 (FIG. 3A) or NCCL for short, is illustrated by a thick, bold and patterned line. In such fashion, Original Communication Lines (OCL) like those depicted in previous figures (FIGS. 1A, 1B, 1C, 2A and 2B), and New Conceived Communication Lines (NCCL) like that depicted in the present figure (FIG. 3A), can be clearly differentiated from each other (OCL are thin dashed lines, NCCL are bold, patterned lines).

Noteworthy, there are several types of associations which may be intended by an Associative Protocol. In this and futures examples, the associations formed by the Associative Protocols which are then physically represented by the System involved within the particular Networks are and will remain to be semantic and/or of a grammatical nature. Other types of associations may be desired and formed without departing from the scope and spirit of the disclosed inventive method.

FIG. 3B is a non-limiting exemplary block diagram illustration of the step depicted in FIG. 3A, this time involving a Data String comprising elements which do not form any type of association between them. Accordingly, a Data String 3100 (FIG. 3B) such as “ran talked” is analyzed implementing an Associative Protocol 3300 (FIG. 3B), such as CIRN, to verify and/or discover if an association is present and/or possible between the elements of the said Data String. In this particular example, no association is found or verified between the elements of said Data String. As result, no data transmission is provided to any system in the Network 1000 (FIG. 3B). Consequentially, the communication line or OCL 1025 (FIG. 3B) between the First System 1011 (FIG. 3B) or the system of *Mary, and the Second System 1012 (FIG. 3B) or system of *silly, remains un-changed (is a dashed line).

FIG. 3C is a non-limiting exemplary block diagram illustration of a variation of the step described in FIG. 3A, which this time involves the network originally depicted in FIG. 1B. In this example, another Data String 3100 (FIG. 3C) or “silly Mary” is once again analyzed for element associations implementing an Associative Protocol 3300 (FIG. 3A), such as CIRN, thus verifying and/or discovering an association between the elements of said Data String. As result, the Data Transmission 3400 (FIG. 3C) is generated and send to the New Conceived Network 3000 (FIG. 3C). Consequentially, the systems corresponding to the association of the elements of the Data String or the First System 1011 (FIG. 3C) representing *silly, and the Second System 1012 (FIG. 3C) representing *Mary, can now communicate across the NCCL 3025 (FIG. 3C). Please note, the depicted NCCL 3025 (FIG. 3C) is illustrated by its corresponding thick, bold and patterned line. On the other hand, no information for associating the remaining system of this example or Third System 1013 (FIG. 3C) was ever generated. As a result, no NCCL are linking the Third System with any other system in the Network.

FIG. 3D is a non-limiting exemplary block diagram illustration of a variation of the step described in FIG. 3C, which this time involves a different Data string such as “Mary is tall.” Accordingly, the Data String 3100 (FIG. 3D) or “Mary is tall” is analyzed for element associations implementing an Associative Protocol 3300 (FIG. 3D), such as CIRN, thus verifying and/or discovering an association between the elements of said Data String. As result, the Data Transmission 3400 (FIG. 3D) is generated and send to the New Conceived Network 3000 (FIG. 3D). Consequentially, the systems corresponding to the associated elements or Second System 1012 (FIG. 3D) representing *Mary, and the Third System 1013 (FIG. 3D) representing *tall, can now communicate across the NCCL 3027 (FIG. 3D). Please note, the depicted NCCL 3027 (FIG. 3D) is depicted by its corresponding formality (a thick, bold and patterned line). On the other hand, no information for associating the remaining system of this example or First System 1011 (FIG. 3D) was generated in this example. As a result, no NCCL are linking the First System of the Network.

FIG. 3E is a non-limiting exemplary flow diagram illustration of two identical steps of the inventive method, each occurring in different periods. Accordingly, the First Data String 3101 (FIG. 3E) or “silly Mary” is analyzed for element associations implementing an Associative Procedure 3301 (FIG. 3E), such as CIRN. An association between the elements of said First Data String is found thus resulting in the First Data Transmission 3401 (FIG. 3E) which is send to at least one of the corresponding systems of the New Conceived Network 3000 (FIG. 3E). Consequentially, the First System 1011 (FIG. 3E) representing silly (*silly), and the Second System 1012 (FIG. 3E) representing Mary (*Mary) are linked (communicate) across their respective NCCL 3025 (FIG. 3E). Then, a Second Data String 3102 (FIG. 3E) or “Mary is tall” at a later period in time, is analyzed for element associations implementing an Associative Procedure 3302 (FIG. 3E), such as CIRN. Indeed, another association between the elements of said Second Data String is found thus resulting in a Second Data Transmission 3402 (FIG. 3E) which sends data to at least one of the corresponding systems on the New Conceived Network 3000 (FIG. 3E). Consequentially, the Second System 1012 (FIG. 3E) representing Mary (*Mary), and the Third System 1013 (FIG. 3E) representing “tall” (*tall) are linked (communicate) across their respective NCCL 3027 (FIG. 3E). As a result, the network now comprises the information from both Data Strings (First Data String and Second Data String). In fact, it could be said, that the network has learned the information provided by both data strings, further enabling the network to learn/represent more future information while maintaining current and old information. Noteworthy, the Second System 1012 (FIG. 3E) representing “Mary” (*Mary) is now linked or associated to several other systems via several NCCL, which differ from current links or communications such as those formed by OCL. But most importantly, the Second System (*Mary), has successfully linked the information intended by both different Data Strings in a single structure and/or network. In addition, please note how the communications between the First System (*silly) and the Third System (*tall) never really evolved from a OCL to a NCCL. This is because no data or association was ever found or provided (may never be found) to justify their communications or evolution.

FIG. 3F is a non-limiting exemplary flow diagram illustration of a variation of the inventive method depicted in FIG. 3E, involving a data string which instead of being responsible for generating the evolution of an OCL into a NCCL, it reverses a NCCL to an OCL type communication. Accordingly, the Data String 3103 (FIG. 3F) or “Mary is not silly” is analyzed for element associations or dis-associations implementing a Dis-Associative Protocol 3303 (FIG. 3F). As a result, a negative association and/or association removal, and/or dis-association is found to occur between the elements of said Data String, thus resulting in the Data Transmission 3403 (FIG. 3F) which is sent to at least one of the corresponding systems of the Old Conceived Network 3000 (FIG. 3F). Please note, in this particular example there are two network illustrations of the same network depicting the past stage or past configuration (Old), and the updated, evolved and/or later configuration (New). Respectively, the Old Conceived Network 3000 (FIG. 3F) is replaced with the New Conceived Network 3003 (FIG. 3F). In the Old Conceived Network 3000 (FIG. 3F), the Second System 1012A (FIG. 3F) representing “Mary” (*Mary) is linked (communicates) with the First System 1011A (FIG. 3F) representing “silly” (*silly) via a Previous NCCL 3025 (FIG. 3F). However, because of the information provided by the Data String, the communications between the systems is revised and/or changed as illustrated in the New Conceived Network 3003 (FIG. 3F) which depicts the same systems or Second System 1012B (FIG. 3F) and First System 1011B (FIG. 3F) but this time both communicate via a Resulting OCL 3325 (FIG. 3F). As a result, communications between the respective systems is modified to reflect the new information, even when said information (Data String) implies modifying an existing NCCL.

FIG. 3G is a non-limiting exemplary flow diagram illustration of identical steps of the inventive method occurring in different periods which were described in FIG. 3E, this time implementing a similar network to that of FIG. 1C. Accordingly, the First Data String 3101 (FIG. 3G) or “Mary is a girl” is analyzed for element associations implementing an Associative Protocol 3301 (FIG. 3E), such as CIRN. An association between the elements of said First Data String is found thus resulting in the First Data Transmission 3401 (FIG. 3G) which is sent to at least one of the corresponding systems of the New Conceived Network 3000 (FIG. 3G). Consequentially, the First System or *Mary System 1011 (FIG. 3G), and the Second System or *girl System 1012 (FIG. 3E) are linked or now communicate through the Group Server 1040 (FIG. 3G) across the Mary-Girl NCCL 3030 (FIG. 3G), which in this example comprises two communication lines going across the Group Server. On the other hand, the Second Data String 3102 (FIG. 3G) or “a girl is a human” which occurs at a later period in time, is analyzed for element associations implementing its respective Associative Protocol 3302 (FIG. 3G) finding a desired association between its corresponding elements/systems, thus resulting in a Second Data Transmission 3402 (FIG. 3G) which is sent to at least one of the corresponding systems and/or Group Server of the New Conceived Network 3000 (FIG. 3G). Consequentially, the *Girl System 1012 (FIG. 3G) and the *Human System 1013 (FIG. 3G) are linked (communicate) across their newly and respectively formed Girl-Human NCCL 3032 (FIG. 3G). As a result, the network now effectively represents and/or comprises the information provided by both Data Strings (“Mary is a girl” and “a girl is a human”). In fact, it could be said, that the network has learned the information provided by both data strings, further enabling, via a network of systems and NCCL, to identify, find, represent and/or ultimately register, that indeed, “Mary is also a human” (because she is a girl), thus effectively linking the information intended or described by both Data Strings while permitting conclusive and/or deductive behavior from both data sets. Furthermore, the network can grow as new information arrives and the new and/or present respective systems become involved allowing for new links and/or sub-networks to effectively represent unmentioned, required and/or to be discovered data.

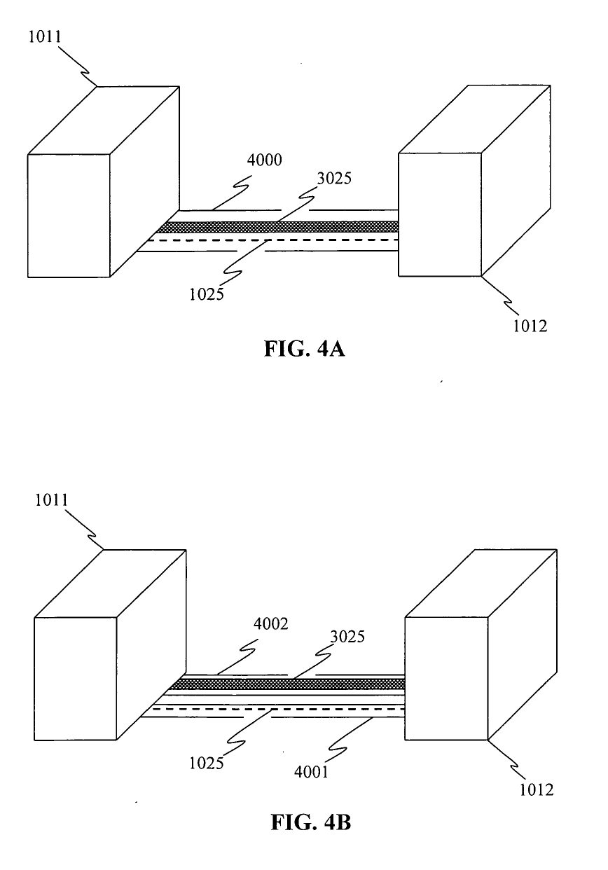

FIG. 4A is a non-limiting illustration of a network of two systems communicating across an OCL and NCCL. Accordingly, the First System 1011 (FIG. 4A) communicates with the Second System 1012 (FIG. 4A) across a Communication Path 4000 (FIG. 4A) such as a wire, an electromagnetic signal, etc. Please note, the Communication Path depicts two different lines such as the OCL 1025 (FIG. 4A) and the NCCL 3025 (FIG. 4A). The OCL are communications implementing basic communication protocols such as those which are typically found in normal network configurations, thus allowing both systems to communicate with each other when needed, requested, etc. However, the NCCL 3025 (FIG. 4A) communications between the system implement a different communications protocol, such as encryptions, formats, speeds, passwords, signal magnitudes, etc. thus differing from current or other communication protocols. In such fashion, when a NCCL is established, both systems may communicate implementing different communication protocols; wherein said communication protocols may be used to identify a specific type of association between said systems identifying their respective concepts (i.e., *Mary).

FIG. 4B is a non-limiting illustration of a network of two systems communicating across an OCL and a NCCL. Accordingly, the First System 1011 (FIG. 4B) communicates with the Second System 1012 (FIG. 4B) across a First Communication Path 4001 (FIG. 4B) such as a wire, an electromagnetic signal, etc. Please note, the First Communication Path depicts only one communication line or OCL 1025 (FIG. 4B), thus exclusive working for a specific range of communication protocols, such as those assigned for OCL type associations/communications. The Second Communications Path 4002 (FIG. 4B) depicts only its corresponding NCCL 3025 (FIG. 4B), thus exclusively working on different communications protocols such as encryptions, formats, speeds, passwords, signal magnitudes, etc. As a result, active NCCL communications can be used to identify specific types of association between said system identifying their respective concepts.

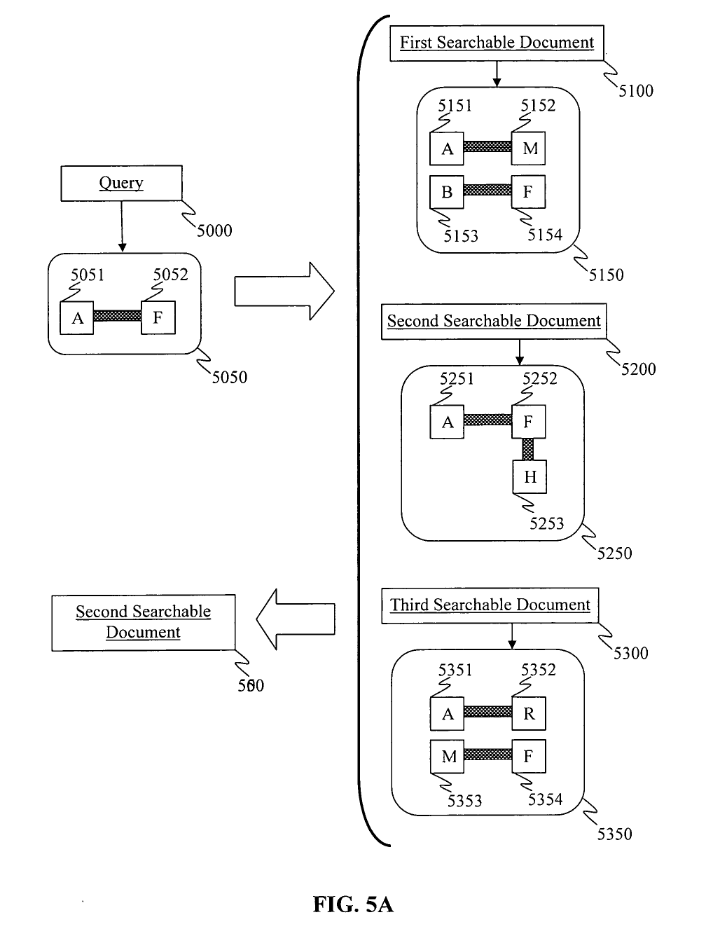

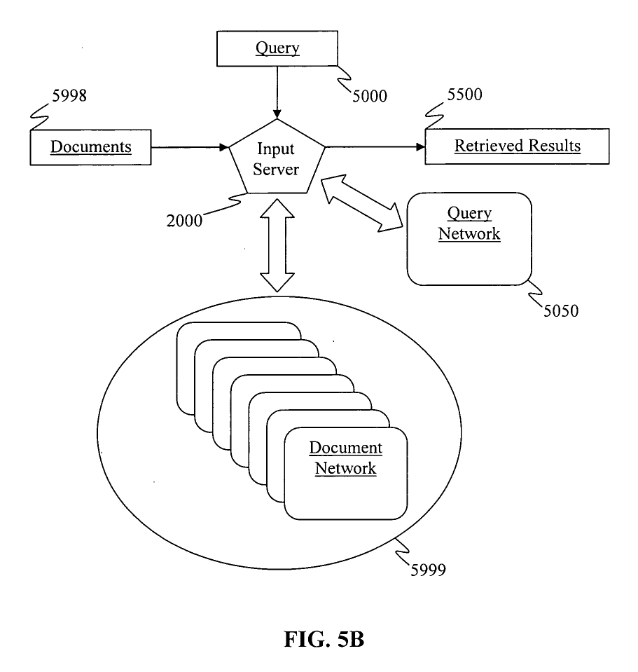

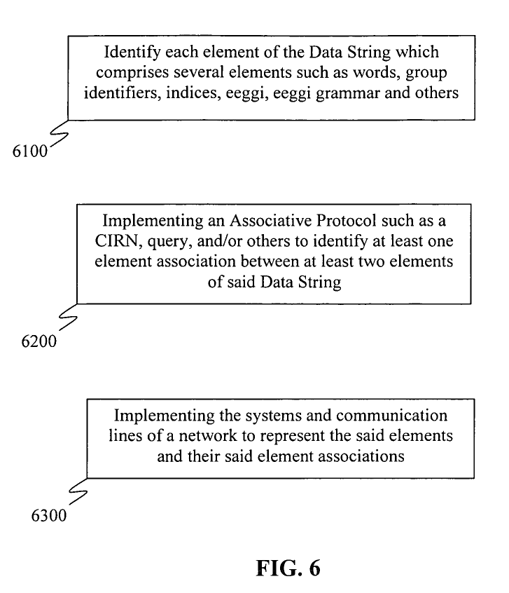

FIG. 5A is a non-limiting exemplary block diagram illustration of steps and systems of the inventive method handling an information function or application such as that of a search and/or a search engine. The Query 5000 (FIG. 5A) is responsible for forming its corresponding Query Network 5050 (FIG. 5) comprising several systems and associations or NCCL (such as links) representing their corresponding elements of the Query with their respective associations (if any). In similar fashion, the First Searchable Document 5100 (FIG. 5A) forms its corresponding First Document Network 5150 (FIG. 5A), the Second Searchable Document 5200 (FIG. 5A) forms its corresponding Second Document Network 5250 (FIG. 5A), and the Third Searchable Document 5300 (FIG. 5A) is responsible for forming its corresponding Third Document Network 5350 (FIG. 5A). Comparing the different networks and respective systems with that of the Query it can be observed that: in this particular example, the Query Network 5050 (FIG. 5A) links the A System 5051 (FIG. 5A) with the F System 5052 (FIG. 5A). However, the First Document Network 5150 (FIG. 5A), links the A System 5151 (FIG. 5A) to an M System 5152 (FIG. 5A), and separately, the F System 5154 (FIG. 5A) links to a B System 5153 (FIG. 5A); consequentially, there is no match and the corresponding First Searchable Document, is not retrieved or displayed in the Retrieved Documents 5500 (FIG. 5A). But, the Second Document Network 5250 (FIG. 5A), does link its A System 5251 (FIG. 5A) to its F System 5252 (FIG. 5A), therefore, there is a match and the corresponding Second Searchable Document, is retrieved and/or displayed in the Retrieved Documents 5500 (FIG. 5A). Please note, even when its F System 5252 (FIG. 5A) is additionally linked to an H System 5253 (FIG. 5A) that does not change the fact of a “network match” between the Query and the Second Document Network. Finally, the Third Document Network 5350 (FIG. 5A), links its respective A System 5151 (FIG. 5A) to an R System 5352 (FIG. 5A), while separately linking its respective F System 5354 (FIG. 5A) to a undesired M System 5353 (FIG. 5A); consequentially, there is no match and the corresponding Third Searchable Document, is not retrieved or displayed in the Retrieved Documents 5500 (FIG. 5A).

FIG. 5B is a non-limiting block diagram illustration of a prospective structure and systems applicable to the non-limiting description of the method of FIG. 5A. Accordingly, the Input Server 2000 (FIG. 5B) receives a Query 5000 (FIG. 5B) and allocates and/or assigns the Query information to a respective Query Network 5050 (FIG. 5B). Then, The Input Server 2000 (FIG. 5B) collects and/or receives a series of Documents 5998 (FIG. 5B) and allocates and/or assigns the particular document's information on several Document Networks 5999 (FIG. 5B). Finally, the Input Serves collects and/or allows for comparisons of the Query Network with each of the Document Network for producing and/or providing the Retrieved Results 5500 (FIG. 5B). Noteworthy, this example also illustrates irrelevance avoidance or removal by only permitting or selecting only those documents that have the same associations (conceptual, virtual and/or physical networks) as the query. For example, according to the Associative Protocols, a string such as “pretty Mary” associates in identical fashion (forms the same network) that “Mary is pretty” does; but differs completely from the associations (formed networks) corresponding to “Mary is silly and Diana is pretty.”

FIG. 6 is a non-limiting block diagram of several steps of the inventive method. Accordingly, the First Step 6100 (FIG. 6) involves the step of identifying every element in a data corpus or data string; wherein the elements can be at least one of a: word, group of words, group identifier, eeggi, eeggi-grammar, eeggi-index, etc. Basically, identifying every information directly and/or indirectly identifying a word and/or its corresponding concept. The Second Step 6200 (FIG. 6) involves the step of implementing an Associative Protocol such as a CIRN or other to identify, verify, or discover several types of desired or required associations such as semantic, grammatical, conceptual and others. Finally, the Third Step 6300 (FIG. 6) involves implementing system networks to represent said desired or required associations.

Noteworthy, within the several types of networks (wireless, Intranet, Internet, etc.), there are several possible configurations, comprising different types of network elements (routers, server, secured servers, processors, computers, etc.) each possibly comprising and/or involving several network function, steps of the inventive methods and responsibilities, without ever departing from the main spirit and scope of the inventive method and system.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

### Conclusion

From the foregoing, a novel method and system for dynamically and/or statically identifying, registering, comparing, and manipulating information can be appreciated. The described method overcomes many of the limitations encountered by current information technologies such as databases, and information applications such as search engines, speech recognition, word processors, and others which fail to effectively associate relating data and dynamically grow with new information.

1. A method for retrieving information comprising the steps of:
a) Identifying a first association between several abstract elements in a query corpus; wherein each abstract element is ultimately capable of identifying at least one of a: corresponding word, corresponding group of words, corresponding concept, and corresponding group of concepts,
b) Identifying said first association in a data corpus
c) Retrieving said data corpus.

2. A method for identifying new information comprising the steps of:
a) Identifying a plurality of systems in a network,
b) Implementing said plurality of system for identifying a plurality of elements; wherein said elements identify at least one of a: word, group of words, concept and group of concepts,
c) Identifying an association between a plurality of systems implementing an associative protocol such as CIRN,
d) Modifying said network to represent said association between said plurality of systems.

3. A method of implementing a network for representing information comprising the steps of:
a) Identifying a first abstract element in a data corpus; wherein said first abstract element is capable of ultimately identifying at least one of a word, group of words, concept and group of concepts,
b) Identifying a Second abstract element in said data corpus; wherein said second abstract element is capable of ultimately identifying at least one of a word, group of words, concept and group of concepts,
c) Identifying an association between said first abstract element and said second abstract element implementing an associative protocol, such as a CIRN,
d) Implementing a first system to identify said first abstract element,
e) Implementing a second system to identify said second abstract element,
f) Associating said first system and said second system, implementing an association structure such as a network.

4. A method for registering information comprising the steps of:
a) Identifying each element of the data corpus; wherein said data corpus comprises several elements, such as words, text, group identifiers, eeggi, and eeggi-grammar,
b) Identifying an association between a plurality of said elements implementing an Associative Protocol, such as CIRN,
c) Implementing a network to represent the said elements and the said element association.
